(19) United States
(12) Patent Application Publication
(10) Pub. No.: US 2006/0104783 A1
(43) Pub. Date: May 18, 2006

(54) Industrial truck having a cylinder which is rigidly connected to a load displacement device

(76) Inventor: Klaus Schroder, Beilngries (DE)

Correspondence Address: EDWARDS & ANGELL, LLP, P.O. BOX 55874, BOSTON, MA, 02205, US

(21) Appl. No.: 11/217,984

(22) Filed: Sep. 1, 2005

(30) Foreign Application Priority Data
Sep. 1, 2004 (DE) 10 2004 042 336.9

(51) Int. Cl. B66F 9/14

(52) U.S. Cl. 414/667

(57) ABSTRACT

The invention relates to an industrial truck (10) having a load displacement device (12, 14, 16, 18) which comprises two device parts (12, 14, 19, 20), which can be substantially displaced relative to one another along a displacement axis (V), and at least one piston/cylinder system (30, 60) for the purpose of providing a force required for a relative displacement of the device parts (12, 14, 19, 20), a piston (32) of the piston/cylinder system (30, 60) being connected to one of the device parts (14, 20), and a cylinder (34, 64) of the piston/cylinder system (30, 60) being connected to the respective other one of the device parts (12, 19). According to the invention, the cylinder (34, 64) is rigidly connected to the device part (12, 19) associated with it such that torques acting about a torsion axis (T) extending in the cylinder longitudinal direction (L, L′) and/or tensile and/or compression forces acting substantially in the cylinder longitudinal direction (L, L′) and/or bending moments acting about a bending axis (W, W′) extending substantially orthogonally with respect to the cylinder longitudinal direction (L, L′) can be transmitted from the device part (12, 19) at least to a longitudinal section (34b) of the cylinder (34, 64), in particular of the cylinder casing.

The present invention relates to an industrial truck having a load displacement device which comprises two device parts, which can be substantially displaced relative to one another along a displacement axis, and at least one piston/cylinder system for the purpose of providing a force required for a relative displacement of the device parts, a piston of the piston/cylinder system being connected to one of the device parts, and a cylinder of the piston/cylinder system being connected to the respective other one of the device parts.

Industrial trucks of this type are generally known in the prior art. Possible load displacement devices are a lifting mast, an additional lifting device, a lateral reach device or the like. In the known industrial trucks, the cylinder of the at least one piston/cylinder system is generally articulated on the device part associated with it at its longitudinal end which lies opposite the piston exit end. In order to provide further support, the cylinder generally passes through a perforated matrix which is offset from the point of articulation towards the piston exit end and is fixedly connected to the device part associated with the cylinder.

The perforated matrix holds the cylinder only roughly in position and thus prevents the piston/cylinder system from being bent out when the piston is extended to a great extent. However, the point at which the cylinder is supported on the perforated matrix is generally not designed to transmit notable forces to the cylinder. A relative movement between the perforated matrix and the cylinder along the cylinder longitudinal axis and about said cylinder longitudinal axis is permitted.

In the case of industrial trucks and the load displacement devices, which are provided on them and are generally steel shell structures, the rigidity of the load displacement device is an important factor in relation to operational reliability and operational efficiency. It is therefore one object of the present invention to provide a generic industrial truck, whose load displacement device is of more rigid design than the industrial trucks of the prior art without further components being fitted, i.e. whilst avoiding an increase in weight and additional assembly work.

This object is achieved according to the invention by the fact that the cylinder is rigidly connected to the device part associated with it such that torques acting about a torsion axis extending in the cylinder longitudinal direction and/or tensile and/or compression forces acting substantially in the cylinder longitudinal direction and/or bending moments acting about a bending axis extending substantially orthogonally with respect to the cylinder longitudinal direction can be transmitted from the device part at least to a longitudinal section of the cylinder, in particular of the cylinder casing.

Such torques can occur in a load displacement device, for example, when the load displacement device has a lateral reach device on which a load is accommodated in the lateral direction of the vehicle with respect to a vehicle longitudinal central plane, and the industrial truck having a load accommodated in this manner accelerates or brakes.

Tensile and/or compression forces can be brought about by a bending moment acting on the load displacement device, for example, when the load, as is conventional with stackers and order pickers, is accommodated such that the center of gravity of the load is arranged at a distance from the displaceable device parts. If the load is lifted, the distance of the center of gravity of the load from the point of attachment of the stand of a lifting mast on the frame of the industrial truck forms a load arm such that a bending moment acts on the lifting mast about a bending axis extending substantially in the transverse direction of the industrial truck.

Owing to the rigid connection according to the invention of the cylinder to the device part associated with it, the cylinder is part of the steel shell structure of the load displacement device and contributes to its overall rigidity. Owing to the increased overall rigidity, the same load leads to less deformation than in the prior art. Furthermore, the increased overall rigidity of the load displacement device given approximately the same weight leads to an increase in the natural frequencies which can be excited on the load displacement device, with the result that the applied load, which is the same as in the prior art, in addition to less deformation also brings about a higher-frequency oscillation of the load displacement device, which is damped more rapidly owing to the higher frequency by internal and external friction than is the case in the prior art.

It is further advantageous for the piston/cylinder unit to be provided in any case, and it is thus possible for the increased overall rigidity of the load displacement device to be realized substantially without the weight being increased or even with an inherent reduction in weight owing to the perforated matrices being omitted.

According to the invention, the cylinder can be connected to the device part associated with it such that only a load comprising the torque, tensile and/or compression force or bending moment can be transmitted from the device part to the cylinder. For overall rigidity of the load displacement device which is as high as possible, it is advantageous, however, if the cylinder is rigidly connected to the device part such that both torque, tensile and/or compression forces and bending moments can be introduced into the cylinder from the device part.

A rigid connection of the cylinder to the respective device part is particularly suitable for force, moment and/or torque transmission when a relative movement between the cylinder and the device part in the direction of action of the force, moment and/or torque is substantially completely prevented.

In general, a rigid connection is designed to transmit forces, moments and torques from each of two components to the respective other component, i.e. bidirectionally. It will even be the rule in the present invention for torques, tensile and/or compression forces or bending moments to be capable of being transmitted bidirectionally in such a way between the cylinder and the device part. However, it is critical that such forces, moments and torques can be transmitted from the device part to the cylinder since it is of principle concern that forces acting on the load displacement device from outside, i.e. generally from the accommodated load, are absorbed on the load displacement device.

In particular, the cylinder casing which lies between the longitudinal ends of the cylinder is suitable for absorbing torques, tensile and/or compression forces or bending moments, since it is a homogeneous body over a considerable proportion of the cylinder length which as a result leads to substantially homogeneous material loading which puts less strain on the loaded material.

The longitudinal section of the cylinder, to which forces, moments and torques can be transmitted from the device part owing to the rigid connection to the device part associated with it, can thus be incorporated, as an additional torsion spring and/or bending spring and/or as a tension and/or compression rod, in the shell structure of the load displacement device.

In order to transmit forces, moments and torques to the cylinder, said cylinder can be connected directly to the device part associated with it. This means that a cylinder outer surface is connected directly to a surface of the device part in an interlocking manner or by techniques such as soldering, bonding or welding. In the case of a direct connection, at least one section of the cylinder outer wall is preferably welded directly to the device part.

As an alternative or in addition, the cylinder may also be connected to the device part indirectly, i.e. by means of a holder or a connecting part which is rigidly connected both to the device part and to the cylinder. In turn, the cylinder can be connected in an interlocking manner or by techniques such as soldering, bonding or welding, in particular by means of welding, to the device part for the purpose of ensuring that forces, moments and/or torques are transmitted from the device part to the cylinder. Welding is the easiest connection possibility which allows for both the transmission of torques, bending moments and tensile and compression forces from the device part to the cylinder.

The abovementioned interlocking connection can be achieved, for example, by means of an opening, through which a cylinder section passes, in a cylinder holder, the cylinder outer contour and the opening inner contour bordering one another and bearing against one another in cross section by means of a series of polygons, a toothed section or the like. Tensile and compression forces can be transmitted between the device part and the cylinder in an interlocking manner by a holder, through which the cylinder passes, bearing against a projection, which protrudes in the radial direction from the cylinder outer surface, preferably against a peripheral projection.

The transmission of a load from the load displacement device to the cylinder can be ensured by the cylinder being rigidly connected at at least two connection points, provided at a distance from one another in the cylinder longitudinal direction, to the device part associated with it so as to transmit torsional forces and/or tensile and/or compression forces and/or bending moments to the cylinder.

In the device part associated with the cylinder, bending moments induced by the load accommodated by the industrial truck can be absorbed by the cylinder as tensile and/or compression forces if the at least one piston/cylinder system is provided such that the longitudinal axis of the piston/cylinder system is arranged parallel to a guide axis, which is defined by guide elements of the load displacement device which guide the device parts in their relative movement along the displacement axis. In this case, the tensile and/or compression force to be absorbed by the cylinder is less, owing to the load-induced bending moment on the load displacement device, the greater the offset of the longitudinal axis of the piston/cylinder system from the guide axis of a guide arrangement formed by guide elements.

The guide axis of a guide arrangement can in this case be defined by the points at which a plurality of guide elements of a device part bear against the respective other device part, for example such that a line parallel to the displacement axis is drawn through each point at which a guide element rests on its guide track, the points at which these lines pass through a plane normal to the displacement axis forming corner points of a polygon surrounding a surface, and the resulting guide axis being a parallel line to the displacement axis through the center of gravity of the area bordered by the polygon.

A load displacement device can in this case have a plurality of guide axes, for example in the case of a lifting mast which is generally guided at each side end region in the transverse direction of the industrial truck so as to move along the displacement axis.

A robust design at low cost of the device part associated with the cylinder can be achieved by using a profiled support, which extends along the displacement axis, on the relevant device part. In this case, the manipulation or displacement of the load can take place uninfluenced by the piston/cylinder system with the field of vision of the industrial truck driver being influenced as little as possible if the cylinder is arranged on the device part with its cylinder longitudinal axis parallel to the profiled support, the cylinder longitudinal axis being offset with respect to the profiled support towards that side which points away from a load-accommodating means of the industrial truck.

If the cylinder is used as in the present invention as a torsion spring, tension rod, compression rod and/or as a bending spring, the cylinder is subjected to a certain amount of deformation owing to the forces, moments and torques acting on it from the device part.

In this case, it is possible to prevent the cylinder deformation from inhibiting a fluid movement of the piston in relation to the cylinder by a piston guide means being provided as the only guide for a piston movement of the piston relative to the cylinder substantially in the cylinder longitudinal direction at the exit region of the piston out of the cylinder on the cylinder head.

To be more precise, the piston guide means can be provided on an inner circumferential surface, which points towards the cylinder central longitudinal axis, of the cylinder head and can bear against an outer circumferential surface, which points away from the cylinder central longitudinal axis, of the piston. The piston guide means then forms an intermediate layer between the cylinder inner surface and the piston outer surface and can thus be replaced easily.

A cylinder, in which the piston is only guided in the region of the piston exit from the cylinder so as to move in the cylinder longitudinal direction, is an advantageous embodiment owing to the omitted piston guidance at the piston longitudinal end which continuously penetrates the cylinder and the simplifications associated therewith. Owing to the omitted and otherwise conventional guidance of the piston at the piston longitudinal end which penetrates the cylinder, the cylinder may moreover have any design in large sections of its cylinder casing. In particular, it does not need to have a cylindrical design but may have any desired polyhedral outer and inner circumferential surface. It is merely necessary to provide piston guidance and sufficient sealing against the emergence of hydraulic fluid from the cylinder at the piston exit end of the cylinder.

In accordance with a further aspect of the present invention, as an alternative or in addition to the above features, the present object is achieved, in the case of an industrial truck having a load displacement device which comprises two device parts, which can be substantially displaced relative to one another along a displacement axis, and at least one piston/cylinder system for the purpose of providing a force required for the relative displacement of the device parts, a piston of the piston/cylinder system being connected to one of the device parts, and a cylinder of the piston/cylinder system being provided on the respective other one of the device parts, by the fact that at least one structural component of the device part associated with the cylinder forms a housing wall section of the cylinder.

As a result of the fact that a structural component of the device part associated with the cylinder forms a housing wall section of the cylinder, the cylinder and the device part form, as it were, a single common unit, whose structural rigidity is greater than if a cylinder were to be connected, as a separate component, to a structural component of the device part only indirectly via holders. Furthermore, this integral design reduces the number of components required for producing a device part, such as a stand, with a cylinder provided thereon and shortens the assembly time required.

The components extending the structural component by a cylinder can therefore increase the torsional rigidity and possibly also the bending strength and tensile strength of the device part, with the result that, at the same load as that in the prior art, smaller or lighter structural components can be used without any losses in strength and rigidity.

In other words, the structural component of the device part serves the purpose of limiting a cylinder volume, into which the piston can be withdrawn or out of which it can be extended. The cylinder and the device part associated with it form an integral unit.

In design terms, this can be achieved by the cylinder comprising plate elements, which are rigidly connected to one another and to the at least one structural component so as to form a cavity for the displaceable accommodation of the piston. Since the cylinder is preferably intended to act as a hydraulic cylinder and thus should be able to withstand high pressures, it is preferable for the plate elements to be welded to the at least one structural component. In order to simplify the design and to avoid unnecessarily large dead volumes in the cylinder cavity, the plate elements are preferably flat.

As has already been mentioned above, the device part associated with the cylinder may have a profiled support, which extends substantially along the displacement axis. This profiled support is particularly suitable as the abovementioned at least one structural component since it can form a housing wall section of the cylinder over a sufficient length. The device part associated with the cylinder preferably has two such profiled supports. In such a case, an area provided between the profiled supports can be closed whilst fitting the abovementioned plate elements to the profiled supports so as to form a pressure-tight cylinder cavity when the profiled supports are arranged parallel to one another.

In this case, the plate elements are preferably fitted such that they each span the distance between the two profiled supports such that four plate elements may be sufficient, including the two profiled supports, for providing six side faces for a parallelepipedal or fundamentally rhombic cylinder cavity. Those faces of the plate elements and the profiled supports which point toward the cylinder interior then form the limit faces of the cylinder interior.

As a result of the fact that, in the abovementioned design, plate elements which are as integral as possible connect the two profiled supports, as has already been mentioned above, a particularly torsionally rigid, integral cylinder/device part unit is obtained, with the result that, with the same torsional load and the same rigidity of the overall arrangement, the profiled supports can be designed to be smaller and lighter than in the prior art.

The present invention will be described in more detail below with reference to an exemplary embodiment. In the drawing:

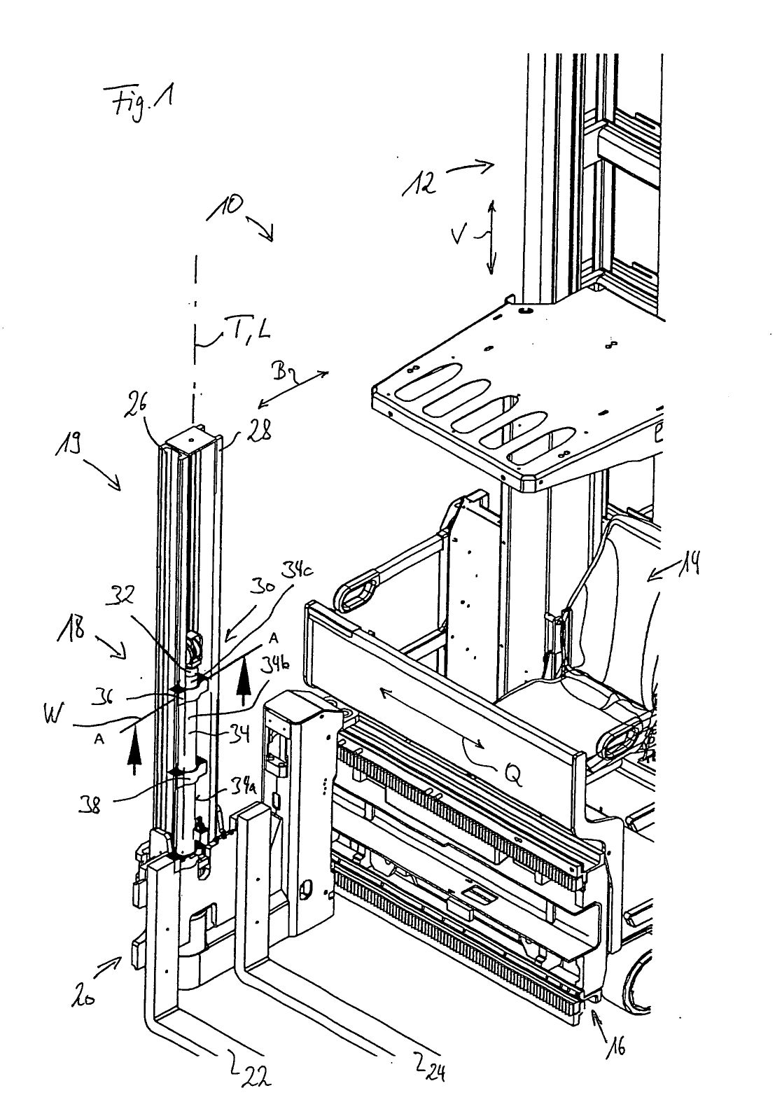

FIG. 1 shows a perspective view of a first embodiment of an industrial truck according to the invention,

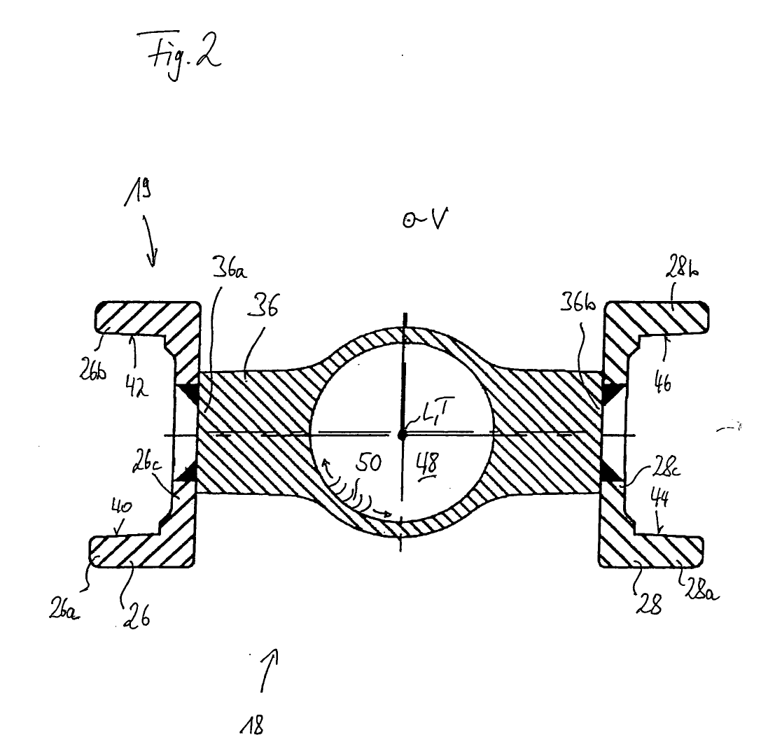

FIG. 2 shows a cross-sectional view of the rigid connection of the cylinder of the additional lifting device to the additional lifting stand,

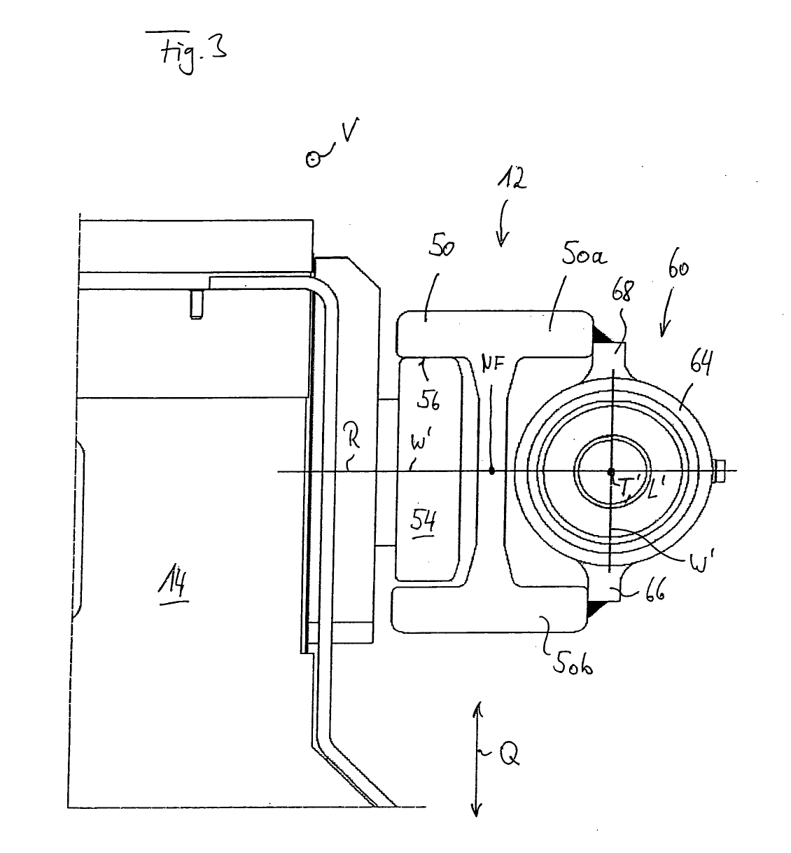

FIG. 3 shows a cross-sectional view through a profiled support of the stand of the lifting mast of the industrial truck in FIG. 1

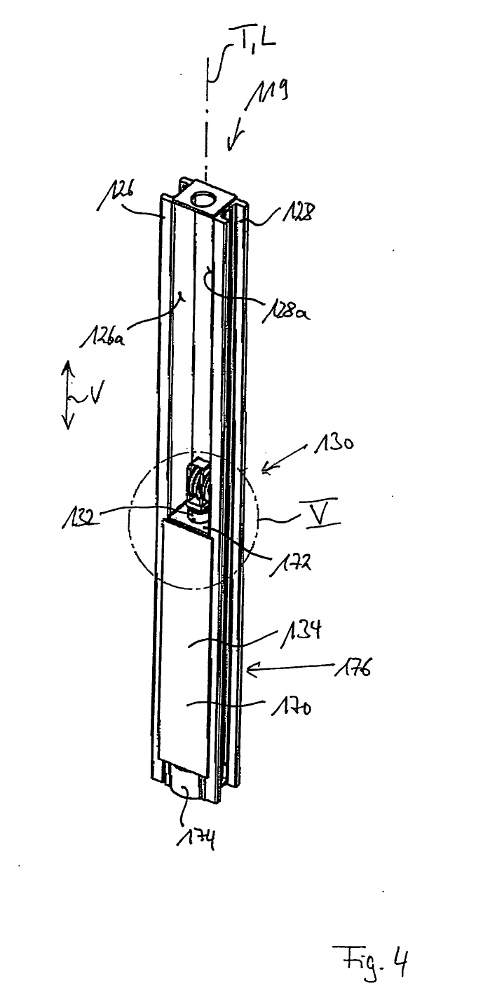

FIG. 4 shows a perspective view of a second embodiment of an additional lifting stand of an industrial truck according to the invention,

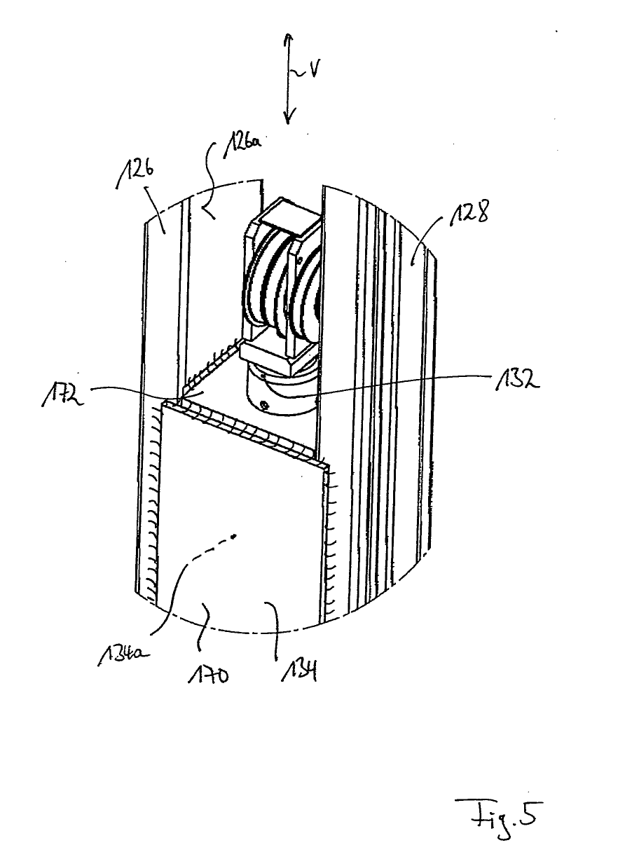

FIG. 5 shows an enlarged illustration of the section indicated by V in FIG. 4,

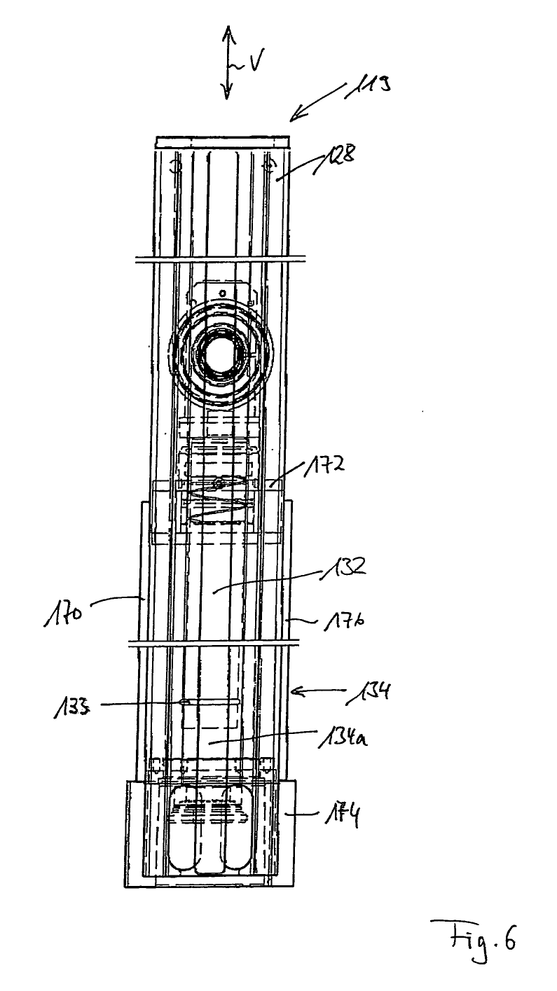

FIG. 6 shows a side view of the additional lifting stand of the second embodiment shown in FIG. 4, and

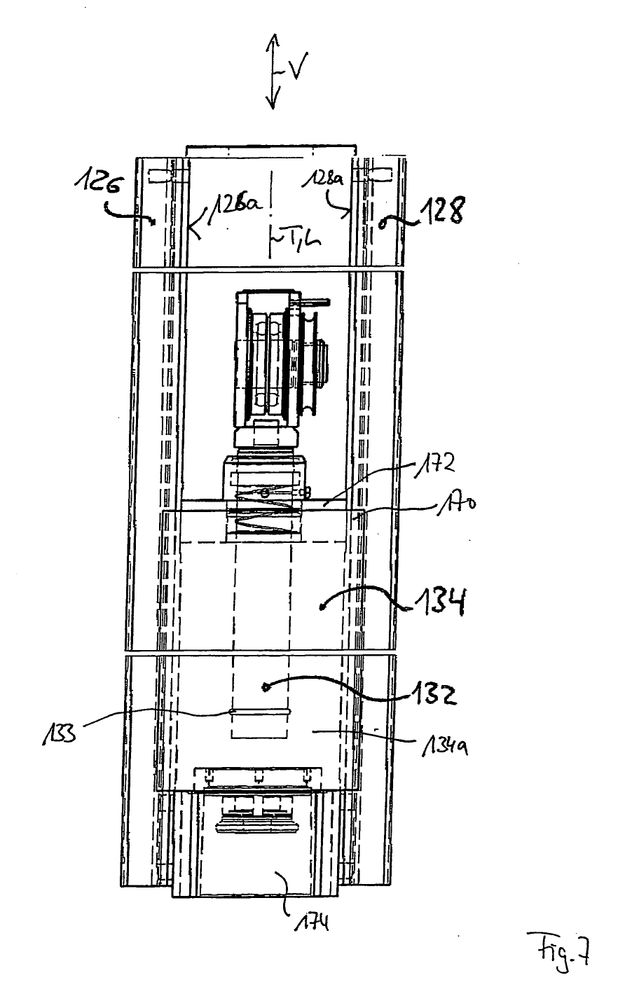

FIG. 7 shows a front view of the additional lifting stand of the second embodiment shown in FIG. 4.

A first embodiment according to the invention of an industrial truck is generally given the reference 10 in FIG. 1. The industrial truck 10 has a lifting mast 12, a driver's platform 14 arranged thereon such that it can move in the direction of the double arrow V, a lateral reach device 16 arranged on the driver's platform 14, and an additional lifting device 18 arranged on the lateral reach device 16. The fork platform 20 bears the two forks 22 and 24 which act as the load-accommodating means of the industrial truck 10.

The additional lifting device 18 has two profiled supports 26 and 28 which are substantially parallel with respect to one another, extend in the direction of the movement direction V and contribute to the formation of an additional lifting device stand 19, and on which the fork carrier 20 is guided so as to move in the direction of the double arrow V.

The profiled supports 26 and 28 are arranged at a distance from one another in the width direction B, which is substantially orthogonal with respect to the displacement direction V, of the fork carrier 20, a piston/cylinder system 30 being arranged between the profiled supports 26 and 28. The piston/cylinder system 30 has a piston and a piston rod 32 which is completely withdrawn into a cylinder 34 of the piston/cylinder system 30 in FIG. 1.

The cylinder 34 of the piston/cylinder system 30 is connected to the profiled supports 26 and 28 belonging to the stand 19 of the additional lifting device 18 by means of two transverse struts 36 and 38. This connection is rigid, both the cylinder outer surface 34a being welded to the transverse struts 36 and 38 and the respective longitudinal ends of the transverse struts 36 and 38 being welded to the profiled supports 26 and 28.

Owing to this type of rigid connection of the cylinder 34 to the stand 19 of the additional lifting device, torques about the torsion axis T, which can be introduced into the stand 19 for example dynamically when the industrial truck with the load accommodated on the fork carrier 20 is driven up or braked, can be transmitted from the stand 19 to the cylinder 34. In this case, the cylinder 34 acts as a torsion spring and additionally makes the stand 19, which comprises the profiled supports 26 and 28, of the additional lifting device 18 more rigid. The torsion axis T shown in FIG. 1 coincides with the longitudinal axis L of the cylinder 34 which is ideally also the longitudinal axis of the piston/cylinder system 30.

If the fork carrier 20 on the additional lifting device 18 with an accommodated load is intended to be lifted very far, a bending moment is introduced into the stand 19 owing to the accommodated load and owing to the distance of its center of gravity from the guide tracks on the profiled supports 26 and 28, said bending moment acting on the stand 19 about a bending axis W which extends in the width direction B. Owing to the rigid connection of the cylinder 34 to the stand 19, such a bending moment is also transmitted to the cylinder 34, with the result that the cylinder 34 acts as a bending spring and increases the bending rigidity of the stand 19. Such a bending moment can be brought about to a great extent dynamically for a short period of time, for example if the industrial truck with an accommodated load and the fork carrier 20 lifted on the additional lifting device 18 traverses a ground beam.

The cylinder section 34b lying between the two transverse struts 36 and 38 can likewise act as a tension rod and compression rod which makes the stand 19 more rigid and which can absorb forces acting on the stand 19 along the cylinder longitudinal axis 34.

Owing to the rigid connection of the cylinder 34 to the stand 19 such that torques, bending moments and tensile and compression forces can be transmitted from the stand 19 to the cylinder 34, the stand 19 of the additional lifting device 18 can be made considerably more rigid without additional components and thus without an increase in weight, which considerably increases operational reliability and efficiency of the industrial truck 10.

Reference is made to the fact that the piston 32 is provided with a piston guide only in the region of the cylinder head 34c, for example from the piston exit end of the cylinder 34 to the lower edge of the upper transverse strut 36. A further piston guide is not provided in the piston/cylinder system 30. As a result, a comparatively great distance can be maintained between the piston outer wall and the cylinder inner wall, for example in the longitudinal section 34b, which lies between the transverse struts 36 and 38, of the cylinder 34, with the result that a load-dependent deformation of the cylinder 34 can be permitted without the piston 32 being prevented from moving into and/or out of the cylinder 34.

FIG. 2 shows a schematic of a cross section through the stand 19 of the additional lifting device 18, the sectional plane lying orthogonally with respect to the cylinder longitudinal axis L and passing through the upper transverse strut 36.

Guide tracks 40, 42, 44 and 46 on which guide rollers of the fork carrier 20 roll for the purpose of guiding the fork carrier 20 (not illustrated in FIG. 2) in the direction of the double arrow V are provided on the outer limbs 26a, 26b, 28a and 28b of the profiled supports 26 and 28. The longitudinal ends 36a and 36b of the transverse strut 36 are welded to the central limbs 26c and 28c, respectively, of the profiled supports 26 and 28, respectively.

The transverse strut 36 has a through-opening 48 through which the cylinder 34 passes, which is likewise not illustrated in FIG. 2 for reasons of clarity. The transverse strut 36 is likewise welded to the outer surface 34a of the cylinder 34 in the region of the through-hole 48, as is indicated by a sector of the weld seam 50.

The connection of the transverse strut 38 to the profiled supports 26 and 28 and to the cylinder 34 is identical to that for the transverse strut 36 described in FIG. 2, with the result that a specific illustration of the transverse strut 38 can be dispensed with whilst referring to the description of the transverse strut 36.

FIG. 3 illustrates a profiled support 50 of the lifting mast 12, the driver's platform 14 being guided on said lifting mast 12 for the purpose of a displacement along the double arrow V. The displacement direction V is orthogonal to the plane of the drawing in FIG. 3, as is already the case in FIG. 2.

In order to guide the driver's platform 14, a guide roller 54, which is mounted on the driver's platform 14 such that it can rotate about a roller axis R, rolls on a guide track 56 on the profiled support 50 of the lifting mast 12.

Express reference is made to the fact that the profiled support 50 is not the only device guiding the driver's platform 14 in the displacement direction V, but that a further profiled support is arranged mirror-symmetrically with respect to the profiled support illustrated in the vehicle transverse direction Q, which is substantially orthogonal with respect to the displacement direction V, at a distance from the profiled support 50.

The displacement force required for displacing the driver's platform 14 is provided by a further piston/cylinder system 60. Projections 66 and 68, which are welded to the longitudinal ends, which point away from the driver's platform 14, of the outer limbs 50a and 50b of the profiled support 50, are formed on the cylinder 64. The cylinder 64, as was previously the case for the cylinder 34 of the additional lifting device 18, is thus also rigidly connected to a profiled support 50 of the lifting mast 52, with the result that a torque about the torsion axis T′, which is oriented orthogonally with respect to the plane of the drawing in FIG. 2 and coincides with the cylinder longitudinal axis L′ of the cylinder 64, can be transmitted from the profiled support 50 to the cylinder 64. A bending moment acting about a bending axis W′ which is parallel to the roller axis R or orthogonal both with respect to the roller axis R and the torsion axis T′ can likewise be introduced into the cylinder 64 from the profiled support 50.

Furthermore, the cylinder 64 has further projections in the cylinder longitudinal direction L′ which are arranged at a distance from one another and correspond to the projections 66 and 68 in FIG. 3, with the result that tensile and compression forces acting orthogonally with respect to the plane of the drawing in FIG. 3 can also be introduced at least in a cylinder section positioned between the spaced-apart projections in the cylinder longitudinal direction L′.

Reference is made to the fact that the previously mentioned, further profiled support for the purpose of guiding the driver's platform is likewise rigidly connected to a further cylinder of a further piston/cylinder system.

It can easily be seen that a bending moment acting about a bending axis which is orthogonal with respect to the roller axis R and the torsion axis T′ can be supported better by the cylinder 64, the greater the distance of the cylinder 64, represented by its cylinder longitudinal axis L′, from the neutral axis NF of the profiled support 50.

In connection with FIGS. 4 to 7, a second embodiment of the present invention will be described below. Identical components to those in FIGS. 1 to 3 are provided with the same references in FIGS. 4 to 7, but increased by the number 100. The second embodiment in FIGS. 4 to 7 will be described below only to the extent to which it differs from the first embodiment, which is illustrated in FIGS. 1 to 3 and to the description of which express reference is made.

The cylinder 134 shown in FIG. 4 is designed such that, as has already been described before, it guides the piston 132 only at the exit-side end of the cylinder 134.

The cylinder 134 is formed by a front plate 170, a cover plate 172, which contains the guide of the piston 132 and the exit opening of the piston 132 from the cylinder 134, a base plate 174 and a rear plate 176 not illustrated in FIG. 4 (cf. FIG. 6). These mentioned plate elements 170 to 176 are welded both to one another and to the profiled supports 126 and 128 of the additional lifting stand 119 such that, apart from the exit opening of the piston 132, an enclosed, pressure-tight cavity is formed in the interior of the cylinder 134. Faces 126a and 128a, pointing toward one another, of the profiled supports 126 and 128, which are formed from inexpensive U-profile semifinished products, form limit walls of the inner volume of the cylinder 134.

FIG. 5 is an enlarged illustration of the piston exit from the cylinder 134. This figure shows how the plate elements 170 and 172, by means of welding, interact both with one another and with the profiled supports 126 and 128 so as to form a pressure-tight cylinder interior 134a.

FIG. 6 shows a side view of the additional lifting stand 119 with a cylinder 134 formed integrally thereon. The piston 132 penetrating the cylinder interior 134a is indicated by dashed lines. An extension of the diameter 133 at the penetrating longitudinal end of the piston 132 prevents the piston 132 from being completely extended out of the cylinder 134.

To supplement this, reference is made to the illustration in FIG. 7.

It is obvious to those skilled in the art that the cylinder 134 has a supply connection, through which fluid can be conveyed into the cylinder interior 134a under pressure in order to extend the piston 132 out of the cylinder 134. Provision is likewise made for the pressure of the fluid, preferably hydraulic oil, to be able to leave the cylinder interior 134a in a controlled manner in order to be able to allow the piston 132 to penetrate the cylinder 134.

1. An industrial truck having a load displacement device which comprises two device parts, which can be substantially displaced relative to one another along a displacement axis (V), and at least one piston/cylinder system for the purpose of providing a force required for a relative displacement of the device parts, a piston of the piston/cylinder system being connected to one of the device parts, and a cylinder of the piston/cylinder system being connected to the respective other one of the device parts, wherein the cylinder is rigidly connected to the device part associated with it such that torques acting about a torsion axis (T) extending in the cylinder longitudinal direction (L, L′) and/or tensile and/or compression forces acting substantially in the cylinder longitudinal direction (L, L′) and/or bending moments acting about a bending axis (W, W′) extending substantially orthogonally with respect to the cylinder longitudinal direction (L, L′) can be transmitted from the device part at least to a longitudinal section the cylinder, in particular of the cylinder casing.

2. The industrial truck as claimed in claim 1, wherein the cylinder is connected directly and/or indirectly in an interlocking manner or by techniques such as soldering, bonding or welding, in particular by means of welding, to the device part associated with it.

3. The industrial truck as claimed in claim 1, wherein the cylinder is rigidly connected at at least two connection points, provided at a distance from one another in the cylinder longitudinal direction (L, L′), to the device part associated with it so as to transmit torsional forces and/or tensile and/or compression forces and/or bending moments to the cylinder.

4. The industrial truck as claimed in claim 1, wherein the at least one piston/cylinder system is provided such that the longitudinal axis (L, L′) of the piston/cylinder system is arranged parallel to a guide axis, which is defined by guide elements of the load displacement device which guide the device parts in their relative movement along the displacement axis (V), such that it is offset with respect to said displacement axis (V).

5. The industrial truck as claimed in claim 4, wherein the device part associated with the cylinder has a profiled support which extends along the displacement axis (V), the cylinder being arranged on the device part with its cylinder longitudinal axis (L, L′) parallel to the profiled support, the cylinder longitudinal axis (L, L′) being offset with respect to the profiled support towards that side which points away from a load-accommodating means of the industrial truck.

6. The industrial truck as claimed in claim 1, wherein a piston guide means is provided as the only guide for a piston movement of the piston relative to the cylinder substantially in the cylinder longitudinal direction (L, L′) at the exit region of the piston out of the cylinder on the cylinder head.

7. The industrial truck as claimed in claim 6, wherein the piston guide means is provided on an inner circumferential surface, which points towards the cylinder longitudinal axis (L, L′), of the cylinder head and bears against an outer circumferential surface, which points away from the cylinder axis, of the piston.

8. A cylinder for an industrial truck the cylinder having the features of claim 6.

9. An industrial truck having a load displacement device which comprises two device parts, which can be substantially displaced relative to one another along a displacement axis (V), and at least one piston/cylinder system for the purpose of providing a force required for the relative displacement of the device parts, a piston of the piston/cylinder system being connected to one of the device parts, and a cylinder of the piston/cylinder system being provided on the respective other one of the device parts, possibly including at least one of the preceding claims, wherein at least one structural component of the device part associated with the cylinder forms a housing wall section of the cylinder.

10. The industrial truck as claimed in claim 9, wherein the cylinder comprises plate elements, preferably flat plate elements, which are rigidly connected to one another and to the at least one structural component, preferably by means of welding, so as to form a cavity for the displaceable accommodation of the piston.

11. The industrial truck as claimed in claim 9, wherein the device part associated with the cylinder has at least one, preferably two, profiled supports, which extend substantially along the displacement axis (V), as the at least one structural component.

12. The industrial truck as claimed in claim 11, wherein the device part associated with the cylinder has two parallel profiled supports, the cylinder being formed between the profiled supports.

13. A cylinder for an industrial truck, wherein the cylinder has the features of claim 7.
